(19) United States
(12) Patent Application Publication
(10) Pub. No.: US 2003/0160882 A1
(43) Pub. Date: Aug. 28, 2003

(54) Video sensor chip circuit

(76) Inventors: Christiane Henno, Tubingen (DE); Roger Bauer, Reutlingen (DE); Roland Cochard, Morges (CH)

Correspondence Address: KENYON & KENYON, ONE BROADWAY, NEW YORK, NY, 10004, US

(21) Appl. No.: 10/204,648

(22) PCT Filed: Feb. 14, 2001
(86) PCT No.: PCT/DE01/00553

(30) Foreign Application Priority Data
Feb. 19, 2000 (DE) 10007689.0

(51) Int. Cl. H04N 3/14; H04N 5/335

(52) U.S. Cl. 348/301; 348/310; 348/308; 250/208.1

(57) ABSTRACT

A circuit arrangement of a video sensor chip has photosensitive pixels arranged in a matrix, each pixel having a phototransistor whose output photoelectric current is amplified logarithmically and sent as a voltage signal to an analyzer circuit.

The pixels (12) and an amplifier (22) assigned to each pixel (12) are monolithically integrated into a common component, the amplifiers (22) being situated outside a photosensitive area (14) of the video sensor chip.

The present invention relates to a circuit arrangement of a video sensor chip having the features specified in the preamble of claim 1.

### BACKGROUND INFORMATION

Video sensor chips of the generic type are known. They include photosensitive pixels arranged in a matrix, defining a photosensitive area of the video sensor chip. Each pixel includes a phototransistor which supplies a photoelectric current as a function of a brightness acting on the respective phototransistor. Changes in brightness result in a proportional change in the photoelectric current.

It is known that this output photoelectric current of the pixels may be amplified logarithmically and sent as a voltage signal to an analyzer circuit. Such a video sensor chip is described in German Patent 42 09 536 C2, for example. However, one disadvantage is that a relatively large photosensitive area is necessary with the known video sensor chip having a logarithmic characteristic curve. This represents a parasitic capacitance and when the lighting intensity is low and there are light-dark transitions, it results in long adjustment times of the voltage output due to the discharge of the parasitic capacitances via a relatively low current of the phototransistor in weak inversion operation.

The result is called a smearing effect, which is a disadvantage at a high image refresh rate in particular.

### ADVANTAGES OF THE PRESENT INVENTION

The circuit arrangement according to the present invention having the features characterized in claim 1 offers the advantage over the related art that it is possible to provide, in a simple manner, a video sensor chip which has only a relatively small photosensitive area and thus small parasitic capacitances and is operable at a high refresh rate without any smearing effect. Due to the fact that the pixels and an amplifier assigned to each pixel are integrated monolithically into a common component, the amplifiers being situated outside a photosensitive area of the video sensor chip, it is advantageously possible to limit the space required for the photosensitive area to the placement of integrated photosensitive pixels, while the respective amplifiers may be implemented in another section of the monolithically integrated component situated outside the photosensitive region.

In particular when, in a preferred embodiment of the present invention, the amplifiers are connected to the pixels by switching elements that are switchable to the pixel matrix by line and/or by column, it is advantageously possible to optionally address the pixels situated in the relatively small photosensitive area. The associated amplifiers are switched by columns and/or lines, depending on the design, in read out of the output signals of the photosensitive pixels. Since they are outside the pixel field (matrix) and are switchable by line and/or column, they may be implemented uni-dimensionally into the monolithically integrated component. This yields considerable savings in chip area.

Furthermore, it is preferable for one amplifier to be switchable by line and/or by column to the matrix of pixels for all pixels of the line and/or of the column. This advantageously yields the result that the current consumption of the entire video sensor chip is reduced because the photosensitive pixels themselves do not require any additional power supply and only one amplifier per line and/or column requires a power supply.

In another preferred embodiment of the present invention, the amplifier is switched as a transimpedance amplifier. Through such a design of the amplifier, the known voltage conversion is utilized by transimpedance amplifiers, the output impedance being determined by the feedback path of the transimpedance amplifiers, in particular their feedback resistance.

Due to such a design, it is possible to convert the photoelectric current of the photosensitive pixels into a proportional voltage without the photoelectric current being integrated over the parasitic capacitance of the sensor area (small sensor area here).

Furthermore, in a preferred embodiment of the present invention, the feedback path of the transimpedance amplifier is formed by a weakly inversely operating transistor, such an inversely operating transistor preferably being assigned to each photosensitive pixel and being switchable to the amplifiers together with the respective photosensitive pixel. This yields a logarithmic conversion between the input signal of the amplifier, i.e., the photoelectric current or the brightness, which is proportional to the photoelectric current, and the output signal of the amplifier, i.e., the voltage excursion at the output of the amplifier. Thus, the transistor which is switched as a feedback resistor does not implement a linear current-voltage conversion but instead implements a logarithmic conversion and may therefore cover a larger brightness range. Furthermore, high output dynamics and thus a high contrast sensitivity may be ensured in this way without losing the advantage of the short optical transient recovery times of the pixels. This permits an especially high refresh rate without any smearing effect.

Other preferred embodiments of the present invention are derived from the other features characterized in the subclaims.

### DRAWINGS

The present invention is explained in greater detail below in exemplary embodiments on the basis of the respective drawings.

FIG. 1 shows a circuit arrangement of a pixel in a first variant of an embodiment;

FIG. 2 shows a circuit arrangement of a pixel in a second variant;

FIG. 3 shows a characteristic curve of the circuit arrangement according to FIG. 2;

FIG. 4 shows additional characteristic curves of the circuit arrangement according to FIGS. 1 and 2 and

FIG. 5 shows a circuit arrangement of the pixel in a third variant.

### DESCRIPTION OF THE EXEMPLARY EMBODIMENTS

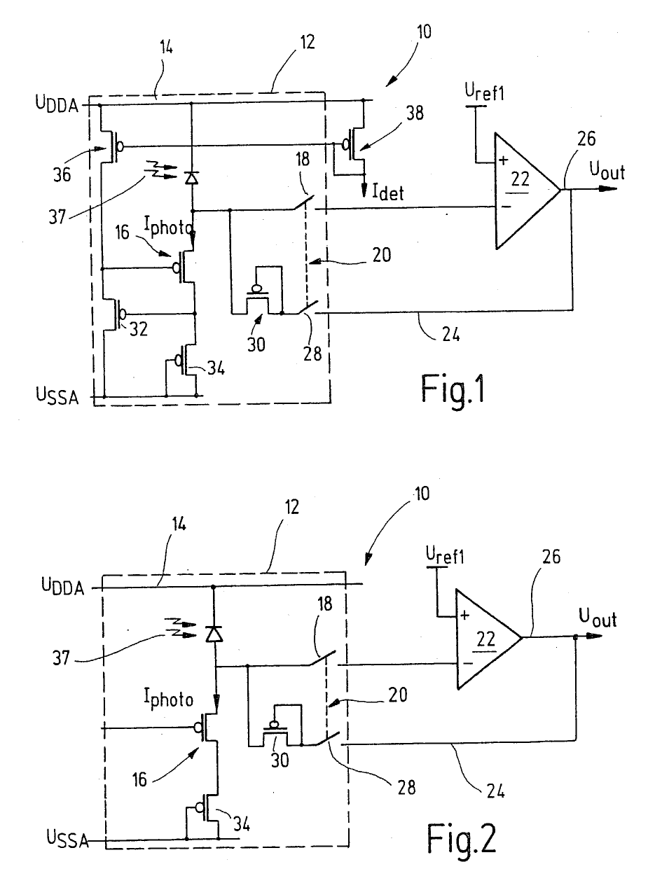

FIG. 1 shows a circuit arrangement 10 of a photosensitive pixel 12 of a video sensor chip (not shown in entirety). The video sensor chip includes a plurality of pixels 12 arranged in a matrix.

In their totality, pixels 12 define a photosensitive area of the video sensor chip, each pixel 12 forming its own subarea 14 thereof (within the area shown with broken lines).

Pixel 12 includes a phototransistor 16. The source terminal of phototransistor 16 is connected via a first switch contact 18 of a switching means 20 to the inverting input of a transimpedance amplifier 22. A reference voltage U_{ref1} is applied to the non-inverting input of a transimpedance amplifier 22. The source terminal of phototransistor 16 is also connected via a feedback branch 24 to output 26 of transimpedance amplifier 22. A switch contact 28 of switching means 20 and a transistor 30, which is switched as a resistor, are situated within feedback path 24. A drain terminal of photoresistor 16 is connected to transistors 32 and 34. Furthermore, pixel 12 includes a current balancing circuit of transistors 36 and 38, which is connected to a gate terminal of phototransistor 16.

Circuit arrangement 10 illustrated in FIG. 1 has the following function:

When light 37 strikes phototransistor 16, a photoelectric current Iₚₕₒₜₒ is generated. This photoelectric current Iₚₕₒₜₒ is directly proportional to the brightness of light 37. Switching means 20 are activated by a line decoder and/or a column decoder. All switching means 20 of pixels 12 arranged in a line of the entire matrix of pixels 12 of the video sensor chip are controlled by an appropriate control pulse, for example. This causes switching contacts 18 and 28 to close. Transistor 30, which is then in closed feedback branch 24, receives current Iₚₕₒₜₒ and converts it to an output voltage Uₒᵤₜ at output 26 of transimpedance amplifier 22. Transistor 30 operates in the operating state of weak inversion, yielding a logarithmic conversion between photoelectric current Iₚₕₒₜₒ and output voltage Uₒᵤₜ. The amplification effect of the negative feedback—due to switching contacts 18 and 28 being closed simultaneously—influences only photoelectric current Iₚₕₒₜₒ because the source voltage of phototransistor 16 does not change. The principle of virtual mass is in effect here. On the whole it is clear that transimpedance amplifier 22 functions as a current-voltage converter, the output impedance of amplifier 22 being determined by feedback branch 24 with transistor 30 switched as a resistor, and transistor 30 (switched as a resistor) implementing the transimpedance. Photoelectric current Iₚₕₒₜₒ changes in proportion to the change in brightness of light 37, so a similarly altered voltage excursion of output voltage Uₒᵤₜ is applied at output 26 with a short response time. Within pixel 12, no parasitic capacitance is acted upon by photoelectric current Iₚₕₒₜₒ, so that charging and/or discharging operations involving this parasitic capacitance do not have any effect on the current-voltage conversion. Logarithmic conversion is achieved using transistor 30 in feedback branch 24, which yields high output dynamics and therefore a high contrast sensitivity of circuit arrangement 10.

An operating point of phototransistor 16 is adjustable via transistors 32 and 34. It is adjusted so that phototransistor 16 always remains in weak inversion operation. The voltage of circuit arrangement 10 is stabilized by transistor 36. Transistors 36 and 38 of the current balancing circuit are dimensioned so that transistor 36 always remains in the operating state of weak inversion even if transistor 38 is in an operating state of strong inversion due to the flow of current I_{det}. Due to this dimensioning, a fixed potential is set at the gate terminal of phototransistor 16, so that the feedback via phototransistor 16 and transistor 32 is inactive.

FIG. 2 shows a modified variant of circuit arrangement 10 in comparison with FIG. 1; the same parts labeled with the same reference notations will not be explained again here. Since a constant voltage is established at the gate terminal of phototransistor 16 due to the dimensioning of the current balancing circuit of transistors 36 and 38, the current balancing circuit of transistors 36 and 38 may therefore be replaced by a reference voltage U_{ref2} applied at the gate terminal of phototransistor 16, as illustrated in FIG. 2. Reference voltage U_{ref2} is selected here so that phototransistor 16 always remains in the operating state of weak inversion. Therefore, no structuring of transistors 32, 36 and 38 is required. This also simplifies the design of circuit arrangement 10, in particular in the area of pixels 12.

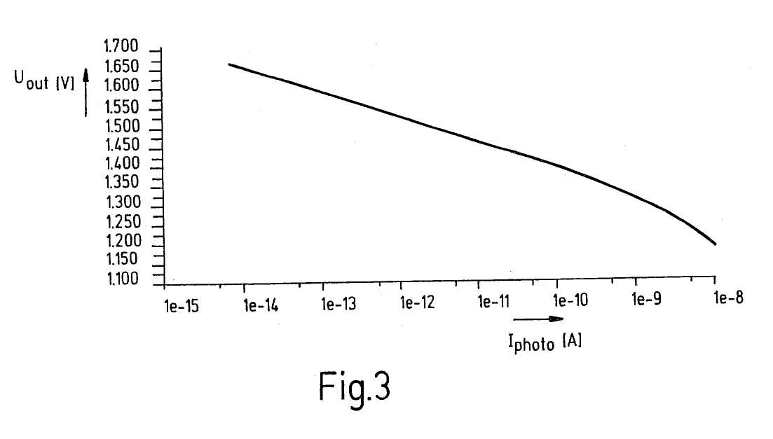

FIG. 3 shows a characteristic curve of circuit arrangement 10, output voltage Uₒᵤₜ being plotted as a function of photoelectric current Iₚₕₒₜₒ which is plotted on a logarithmic scale. The essentially linear characteristic curve of output signal Uₒᵤₜ is clearly shown.

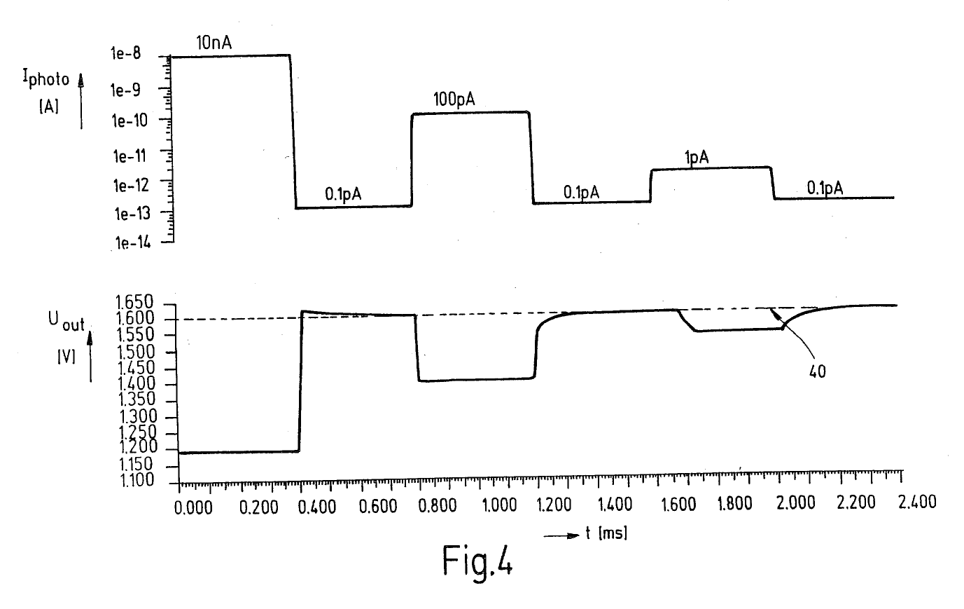

FIG. 4 shows the relationship between a change in photoelectric current Iₚₕₒₜₒ and output voltage Uₒᵤₜ over time t. On the basis of the step response of output voltage Uₒᵤₜ in the case of high contrast (light followed by dark) and in the case of contrast in the range of weak illuminance (dark followed by less dark) it is clear that a step response follows with no delay. A time delay in the step response amounts to approx. 0.4 ms in the worst case. A dotted line 40 corresponds to output voltage Uₒᵤₜ, namely 1.6 V here, for a photoelectric current Iₚₕₒₜₒ of 0.1 pA. Based on this constant photoelectric current Iₚₕₒₜₒ 0.1 pA, proportional photoelectric currents Iₚₕₒₜₒ which result due to the corresponding change in brightness are shown with the corresponding step responses. Since this is a differential input of transimpedance amplifier 22, a higher photoelectric current Iₚₕₒₜₒ results in a lower absolute value of output voltage Uₒᵤₜ, which corresponds to a high difference in comparison with reference voltage U_{ref1}.

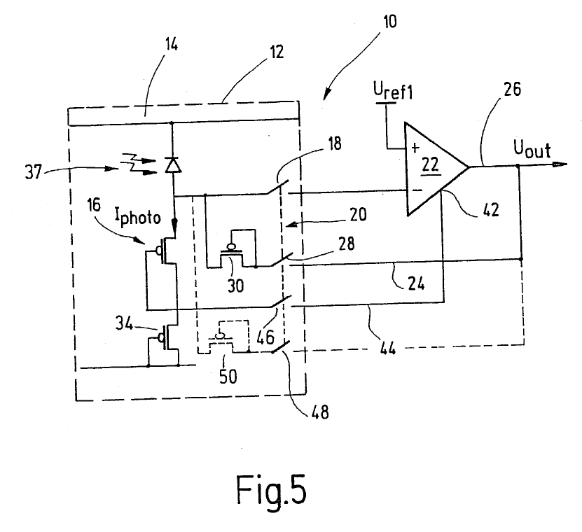

FIG. 5 shows another circuit variant, where the same parts as in FIGS. 1 and 2 are labeled with the same reference numbers and need not be explained again here. In the circuit variant illustrated here, the gate terminal of phototransistor 16 is connected to an amplifier output 42 via a feedback path 44. Another switch contact 46 of switching means 20 is connected into feedback path 44. Feedback path 44 is thus closed simultaneously with feedback path 24 via transistor 30, which is switched as a resistor, and a voltage potential which depends on the photoelectric current is applied to the gate terminal of phototransistor 16 via output 42 of amplifier 22. This voltage potential is in turn a function of photoelectric current Iₚₕₒₜₒ so that operation of phototransistor cell 16 remains in the operating state of weak inversion. This further increases the stability of circuit arrangement 10 and further reduces the smearing effect.

FIG. 5 shows in broken lines another variant, according to which, instead of transistor 30 which operates in weak inversion, a transistor 50 which operates in strong inversion may be connected into feedback path 44. This transistor is triggerable by a switching contact 48 of switching means 20. Such a circuit arrangement makes it possible to implement linear conversion, if desired.

What is claimed is:

1. A circuit arrangement of a video sensor chip comprising photosensitive pixels arranged in a matrix, each pixel having a phototransistor whose output photoelectric current is amplified logarithmically and sent as a voltage signal to an analyzer circuit,
wherein the pixels (12) and an amplifier (22) assigned to each pixel (12) are monolithically integrated in a common component, the amplifiers (22) being situated outside of a photosensitive area (14) of the video sensor chip.

2. The circuit arrangement as recited in claim 1,
wherein the amplifiers (22) are connected to the pixels (12) via switching means (20) switchable to the matrix by line and/or by column.

3. The circuit arrangement as recited in one of the preceding claims,
wherein an amplifier (22) is switchable by line and/or column for all pixels (12) of the line and/or column.

4. The circuit arrangement as recited in one of the preceding claims,
wherein the amplifier (22) is connected as a transimpedance amplifier.

5. The circuit arrangement as recited in one of the preceding claims,
wherein a feedback path (24) of the transimpedance amplifier (22) is formed by a weakly inversely operating transistor (30).

6. The circuit arrangement as recited in claim 5,
wherein the transistor (30) is situated within the photosensitive area (14) and is switchable to the amplifier (22) jointly with each pixel (12).

7. The circuit arrangement as recited in one of the preceding claims,
wherein the phototransistor (16) is operated at a constant gate voltage.

8. The circuit arrangement as recited in claim 7,
wherein the gate terminal of the phototransistor (16) is connected to a current balancing circuit of transistors (36, 38).

9. The circuit arrangement as recited in claim 7,
wherein the gate terminal of the phototransistor (16) is connected to a fixed reference voltage source (U_{ref2}).

10. The circuit arrangement as recited in claim 7,
wherein the gate terminal of the phototransistor (16) is connected via a feedback branch (44) to an output (42) of the amplifier (22) in a manner such that the gate voltage of the phototransistor (16) is a function of the photoelectric current.

11. The circuit arrangement as recited in claim 10,
wherein the feedback branch (44) includes a switching contact (46) of the switching means (20).
